(19) United States
(12) Patent Application Publication
(10) Pub. No.: US 2006/0235769 A1
(43) Pub. Date: Oct. 19, 2006

(54) Automatic categorization and packaging method and system

(75) Inventors: Mei-hsiu Cheng, Taipei (TW); Mei-Chi Kuo, Taipei (TW); Wen-Yi Chang, Taipei (TW); Min-Tzu Sung, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/097,402

(22) Filed: Mar. 31, 2005

(51) Int. Cl. G06Q 99/00

(52) U.S. Cl. 705/28

(57) ABSTRACT

A method and a system for automatic categorization and packaging of the present invention that, based on pre-selected information, automatically arranges a plurality of cargoes on pallets to fill up spaces in the pallets that are not fully occupied, thereby effectively using storage spaces in cargo transport so as to save transportation costs. The automatic categorization and packaging system comprises at least a data accessing module, a pallet arranging module, a pallet capacity determining module, a pallet consolidating module, and a data outputting module for being used in combination with the method to perform the pallet consolidation. Further, information of the process of pallet consolidation is outputted to a management system for allowing production administrators to effectively control flows of cargoes and pallets and increase efficiency of production management as a result.

### FIELD OF THE INVENTION

The present invention relates to methods and systems for production management, and more particularly, to an automatic categorization and packaging method and system for managing the process of stacking cargoes on pallets.

### BACKGROUND OF THE INVENTION

In light of cost concern, manufacturers generally would choose to locate their production factories in areas where raw materials are produced, selling markets are nearby, labor cost is low, or transportation is convenient, in order to cut down production cost. After a manufacturer finishes producing products based on orders received from a client, the finished products need to be packaged and delivered to the client. In the process of delivering the goods, several options of transportation tools can be considered and chosen, for example, airplanes, ships or vehicles depending on the distance and availability of local transportation facilities. Before the goods are transported, they have to be packed into shipping cartons and then arranged on pallets for subsequent transportation.

Conventionally, cargoes are gathered and stacked up by the pallets, which facilitates calculation of the cargoes quantity and dispositions of cargoes within a transport. The use of pallets further facilitates hauling and disposing performed by forklifts or other mechanical equipments. The cargoes on pallets are usually categorized based on orders made by clients. For example, if a single pallet can accommodates 40 cartons of packaged goods, and a client A ordered 100 cartons while a client B who is located in the same delivery area as client A ordered 140 cartons, then under the above-mentioned categorizing rule, it can be deduced that 3 pallets (containing 40, 40 and 20 cartons respectively) are required for client A, and up to four pallets (containing 40, 40, 40 and 20 packaged cartons respectively) are required for client B. In another words, clients A and B will consume a total of seven pallets for storing the cargoes to be delivered, among which there are two pallets that are not fully utilized. This poses a problem since transportation charges are usually based on the number of trips or runs made. Thus, the foregoing two partially vacant pallets would undesirably occupy more storage spaces than is necessary, in particular, when conveyed on expensive transportation tools such as airplanes and ships, thereby increasing transportation costs and decreasing profits.

Therefore, there is a need to develop a system and method for production management that can effectively reduce the number of pallets used for storing cargoes and increase storage space in transport to thereby reduce transportation runs and costs.

### SUMMARY OF THE INVENTION

In light of the disadvantages described in the prior art, a primary objective of the present invention is to provide a method and system for automatic categorization and packaging that, based on selected categories, automatically arranges a plurality of cargoes on pallets to fill up spaces in the pallets that are not fully occupied, thereby effectively using storage spaces in cargo transport so as to save transportation costs.

According to the above and other objectives, the present invention proposes a novel method and system for automatic categorization and packaging, the method comprising the steps of: 1) packing the cargoes to be delivered into individual cartons, printing out data labels containing information that contain at least two items of a client identification number, a destination area, an order type, a product type and a cargo serial number, and affixing the data labels onto each individual carton containing the cargoes; 2) placing packaged cargoes on pallets according to at least two pre-selected items of the information specified in the data labels; 3) determining if all cartons matching the two pre-selected items of the information are placed on the pallets; if not, step (2) is repeated; else, step (4) is followed; 4) determining if there is any pallet which is still not fully occupied; if there is, step (5) is performed, else, step (6) is performed; 5) placing cartons that match at least one but not all of the at least two pre-selected items of the information on the pallets that are not fully occupied; 6) outputting to a management system a message specifying current status and cargo content of each of the pallets and allowing the pallets to be transported to a predetermined destination.

The automatic categorization and packaging system of the invention comprises: a data accessing module for accessing information that includes at least two items of a client material number, a destination address, an order type, a product type and a cargo serial number contained in a data label affixing to a carton; a pallet arranging module for placing on the pallets cartons that match at least two pre-selected items of the information specified in the data label; a pallet storage capacity determining module for determining if a pallet has reached its storage capacity; a pallet consolidating module for placing cargoes that match at least one but not all of at least two pre-selected items of the information on the not-fully-occupied pallets; and a data outputting module for outputting to a management system a message specifying current status of the pallets and product flow.

### BRIEF DESCRIPTION OF THE DRAWINGS

The present invention can be more fully understood by reading the following detailed description of the preferred embodiments, with reference made to the accompanying drawings, wherein:

FIG. 1 is a schematic flowchart showing the steps involved in an automatic categorization and packaging method of the present invention; and

FIG. 2 is a schematic block diagram showing the basic architecture of an automatic categorization and packaging system of the present invention.

### DETAILED DESCRIPTION OF THE PREFERRED EMBODIMENT

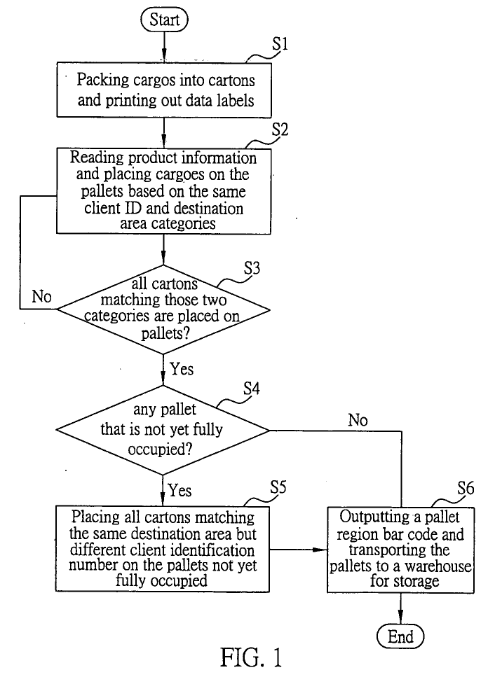

FIG. 1 depicts a flowchart showing the implementation procedure of an automatic categorization and packaging method of the present invention. In step S1, goods to be delivered are packaged into paper cartons and data labels recording information related to the packaged goods (such as client IDs, destination area, type of products, type of order, or cargo serial number) are printed and stuck onto the loaded carton, then, step S2 is performed.

In step S2, an optical scanner is used to read the data label of the cargoes to obtain information of the goods packaged in the cargoes, such that cargoes with the same destination area and same client ID can be arranged in the same pallet. It is noted that the categorization of cartons can be based on more than two items of the information as mentioned above, and it does not have to be those specified above but can be other information, such as the product type, the cargo serial number or order type etc. Thereafter, step S3 is followed.

In step S3, determining if all the cargoes belonging to both items of the information have been placed on the pallets; if not, step S2 is repeated, if so, step S4 is performed.

In step S4, determining if there is any pallet that is not fully occupied with cartons, if yes, step S5 is entered, or otherwise step S6 is performed.

In step S5, placing additional cartons on the pallets until all the pallets are fully occupied, wherein the additional cartons placed on the pallets are those with the same destination area as but a different client ID with the cartons already placed on the pallet in step S2, then step S6 is performed. It should be noted that, in this step, the additional cartons to be placed on the pallet could also be categorized based on the same client ID but a different destination area (or other appropriate items), depending on different applications.

In step S6, transmitting a message to a management system (such as a production information system) and outputting a pallet region bar code affixed to each of the pallets, so as to provide information about product flow and status of pallet for production administrators; subsequently, transferring the pallets to a warehouse for storage or a predetermined destination for transposition.

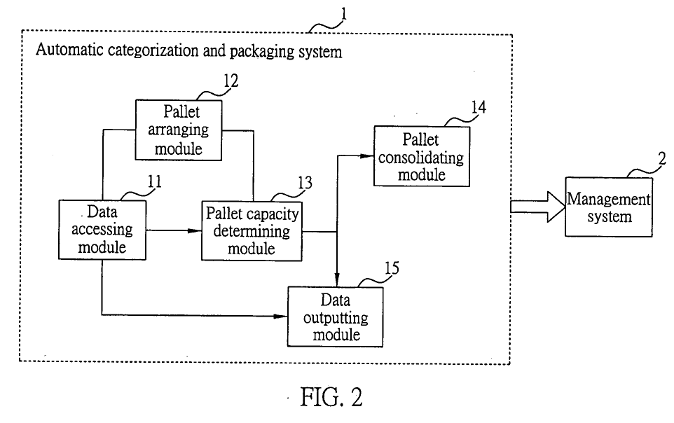

FIG. 2 illustrates the basic structure of the system for automatic categorization and packaging of the invention. As shown, the automatic categorization and packaging system 1 is connected with a management system 2 (such as a factory information system), and essentially includes a data accessing module 11, a pallet arranging module 12, a pallet capacity determining module 13, a pallet consolidating module 14, and a data outputting module 15.

The data accessing module 11 is used for reading bar codes of data affixed to the cartons containing packaged cargoes, so as to collect related information including client ID, destination area, order type, product type, and cargo serial number. After the related information have been collected, the data accessing module 11 will ten transmit the collected information to the management system 2, thereby providing future references to the production administrators when required.

The pallet arranging module 12 is used to place on pallets cargos that match at least two pre-selected items of the information (e.g. the destination area and client ID etc.) specified in the data label.

The pallet capacity determining module 13 is used for determining if the storage capacity for each of the pallets is reached in order to determine whether to consolidate additional cartons onto the pallet not reaching the storage capacity.

The pallet consolidating module 14 is used for consolidating additional cargoes that match at least one pre-selected item of the information of those cartons already stacked on the pallets according to the information provided by the data accessing module 11 until the determining module 13 determines that all pallets have reached full storage capacity, thereby reducing possible transportation costs. Further, the pallet consolidating module 14 transmits the consolidating result to the data outputting module 15.

The data outputting module 15 is used for outputting a pallet region bar code for each of the pallets loaded with cartons to the management system 2, thereby allowing the production administrators to easily identify the product flow and current status of the pallets.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An automatic categorization and packaging method applicable to a cargo distribution process, the method being combined with a management system for managing cargo categorization and comprising the steps of:
1) packing the cargoes to be delivered into individual cartons, followed by printing out a data label for each of the cartons specifying information related to the cargoes packed therein and affixing the data label on each of the cartons;
2) placing on predetermined pallets the cartons with data labels that match at least two pre-selected items of the information;
3) determining if the cartons matching the at least two pre-selected items of the information have all been placed on the pallets, if so, proceeding to step (4); else, step returning to step (2);
4) determining if there is any pallet that is not fully occupied with the cartons, if so, proceeding to step (5); else, proceeding to step (6);
5) placing on the not-fully-occupied pallets cartons that match at least one but not all of the at least two pre-selected items of the information, until all the pallets are fully occupied, then step (6) is performed; and
6) outputting to the management system a message specifying current status and cargo content of each of the pallets and allowing the occupied pallets to be transported.

2. The method of claim 1, wherein the information specified in the data labels contain at least two items of a client identification number, a destination area, an order type, a cargo type and a cargo serial number.

3. The method of claim 2, wherein placing the cartons on the pallets in the step (2) is based on the same client identification number and the destination area.

4. The method of claim 3, wherein placing the cartons on the not-fully-occupied pallets in the step (4) is based on only one of the same client identification number and the same destination area.

5. The method of claim 1, wherein the message outputted to the management system is in the form of a pallet region barcode.

6. The method of claim 1, wherein the management system is a Factory Information System.

7. An automatic categorization and packaging system applicable to a cargo distribution process, the system comprising:
a data accessing module for accessing information contained in data labels affixed to cartons packed with cargoes;
a pallet arranging module used to place on pallets cartons that match at least two pre-selected items of the information specified in the data labels;
a pallet storage capacity determining module for determining if any one of the pallets is yet to be fully occupied;
a pallet consolidating module for placing cartons that match at least one but not all of the at least two pre-selected items of the information on the pallets whose storage capacity have been determined by the pallet storage capacity determining module to be not fully occupied until all the pallets are fully occupied; and
a data outputting module for outputting to a management system a message specifying current status and cargo content of each of the pallets.

8. The system of claim 7, wherein the information specified in the data labels contain at least two items of a client identification number, a destination area, an order type, a cargo type and a cargo serial number.

9. The system of claim 8, wherein the at least two pre-selected items of the information are the client identification number and the destination area.

10. The system of claim 9, wherein the pallet consolidating module places cartons on of the pallets not fully occupied based on only one of the client identification number and the destination area.
